(19) United States
(12) Patent Application Publication
(10) Pub. No.: US 2023/0373707 A1
(43) Pub. Date: Nov. 23, 2023

(54) Packaging System with a Molded Component

(71) Applicant: Aktivax, Inc., Broomfield, CO (US)

(72) Inventor: Amir Genosar, Broomfield, CO (US)

(73) Assignee: Aktivax, Inc, Broomfield, CO (US)

(21) Appl. No.: 18/319,295

(22) Filed: May 17, 2023

Related U.S. Application Data
(60) Provisional application No. 63/343,501, filed on May 18, 2022.

(51) Int. Cl. B65D 83/00; B65D 77/06; B65D 47/12; B65D 35/14; B65D 79/00

(52) U.S. Cl. CPC B65D 83/0055; B65D 77/06; B65D 47/12; B65D 35/14; B65D 79/0084

(57) ABSTRACT

The disclosure provides a packaging system to store a beneficial agent including a primary package with a molded component. The molded component may have a compartment with a flexible wall enclosing a storage volume and a rigid section configured to connect to a secondary package such that the compartment is contained therewithin. The flexible wall may collapse to deplete a beneficial agent from the storage volume through a dispensing port. The flexible wall may be a web material including a monolayer web or multilayer web, and may incorporate a film, a foil, an adhesive, a polymer layer, a metallic layer, and/or a metal oxide layer. The molded component may be a co-molded component formed of a first material and a second material, the first material being molded into a form and joined to a second material. The molded component may be a unitary molded component which consists of one material.

### CROSS-REFERENCE TO RELATED APPLICATIONS

This application claims the benefit of U.S. Provisional Application No. 63/343,501 entitled Collapsible Tube Packaging System and filed on May 18, 2022, the contents of which are incorporated by reference herein for all they contain. In the event of a conflict between the definition or use of any term between the incorporated teachings and the present disclosure, the definition or use in the present application controls.

### BACKGROUND TO THE INVENTION

Medications, and in particular injectable medications, frequently need to be stored sterile in aseptic commercial packages until the time of use. Some medications are stored in pre-filled single dose dispensing devices such as pre-filled syringes. Most injectable medications are stored in aseptic packages and are transferred by a healthcare professional to a dispensing device (i.e., drug delivery device) shortly before use. The term dispensing device includes without limitation hypodermic syringes, micro needle syringes, micropumps, autoinjectors, jet injectors, topical dispensers, intradermal delivery devices, patch pumps, auricular dispensers, oral dispensers, eye droppers, autoinjectors, infusers, prefillable syringes, pre-filled syringes, cartridges for pen injectors, cartridges for auto-injectors, or any other type of drug delivery device.

### SUMMARY OF THE DISCLOSURE

The disclosure provides for a packaging system which may be configured to store a beneficial agent, and which may include a primary package with a molded component. The molded component may have a compartment with a flexible wall enclosing a storage volume and may further include a rigid section configured to connect to a secondary package such that the compartment is contained therewithin. The rigid section may include a flanged section extending radially outward, and may be configured to connect to the secondary package at least partially by the flanged section. The flanged portion may be configured to connect to a secondary package with a seal that seals a secondary volume. The compartment with the flexible wall may be composed of a material substantially inert relative to a substance stored therewithin, including a beneficial agent. As such, the secondary package may be more chemically reactive with the beneficial agent than the flexible wall. The flexible wall itself may be composed of a material less adapted to prevent ingress of spoiling elements when compared to a high barrier material used in the secondary package. A spoiling element may be any substance able to impair the use or usable lifetime of a beneficial agent stored in the storage volume.

The molded component may incorporate a dispensing port through which a beneficial agent contained in the storage volume can be expelled. The molded component may be a co-molded component formed of a first material and a second material, the first material being molded into a form and joined to a second material. The molded component may be a unitary molded component which consists of one material. Whether co-molded or unitary, the molded component may be formed by blow-molding, injection molding, injection blow-molding, or equivalent molding processes, and may include any of polypropylene, polyethylene, cyclic olefin polymer, and/or cyclic olefin copolymer.

The rigid section of the molded component may provide a fluid barrier between a secondary volume within the secondary package and an external environment. The rigid section may have a flange extending radially outward from a fluid channel, the fluid channel providing fluid communication from the storage volume to the dispensing port and/or an external environment. A cross-section of the flange may form a circular, rectangular, or polygonal geometry. The extent of fluid communication provided by the fluid channel may depend on the state of the packaging system; in the closed state a cap, cover, strap, or label may prevent fluid communication to the dispensing port and/or the external environment, while in the opened state such fluid barrier may be removed to allow expulsion through the fluid channel.

The arrangement of the secondary package may be such that pressure equilibrates between the secondary volume and an ambient pressure. This can be accomplished by including a vent which selectively provides fluid communication between the internal volume of the secondary package and an ambient environment, or by manufacture of the secondary package from a permeable material permeable to gases or other fluids. Optionally, such a vent may be disposed in the rigid section of the molded component. A vent may provide a venting pathway configured for fluid communication between the secondary volume and an external environment when the packaging system is in an open state with the cap or other fluid barrier removed. Such pressure equilibration may be controlled by optionally including a cover, strap, label or the equivalent impermeable barrier over a part or the whole of the secondary package. An impermeable barrier may be applied to reduce pressure equilibration when the packaging system is in a storage state for long-term storage of the contents therein, including for long term storage of a beneficial agent. An impermeable barrier may be applied to the packaging system during manufacturing and/or after a fill operation, and may be removable by a user prior to dispensing the contents of the storage volume. The secondary package may be rigid, as with the rigid section of the molded component, or flexible similar to the flexible wall of the compartment. As such, the secondary package may include a molded polymer and/or a web material as described.

The flexible wall may be configured to collapse to deplete a beneficial agent from the storage volume through a dispensing port. The flexible wall may be a web material including a monolayer web or multilayer web, and may incorporate a film, a foil, an adhesive, a polymer layer, a metallic layer, and/or a metal oxide layer. As examples of their respective materials classes, a polymer layer may be formed polypropylene, polyethylene, cyclic olefin polymer, and/or cyclic olefin copolymer, a metallic layer may include aluminum or alloys thereof, and a metal oxide layer could include silicon oxide and/or aluminum oxide.

The primary package may further include a sealed end, which may be sealed against itself as by heat sealing or an equivalent process. Such a configuration and process allows a cap or other fluid barrier to close the dispensing port prior to a fill operation. This may include aseptic integration of the cap or other fluid barrier to the rigid section. This may be advantageous for the manufacturing process of packaging systems for some beneficial agents. A sealed end may provide a fluid barrier preventing fluid communication between the storage volume of the compartment and the secondary volume of the secondary package. In some variations, the sealed end can be sealed with a beneficial agent contained in the storage volume, i.e. a fill-seal process. The primary package can also include an open end configured to allow fluid communication from the storage volume to the dispensing port when the packaging system is in an opened state.

In some variations, this disclosure provides a packaging system with a secondary package comprising a high barrier shell and a collapsible primary package which may comprise a tube with a sealed end and an opened end, a dispensing port, and a vent. A vent may be included in the shell or a rigid flanged section of the collapsible package, and the collapsible package may have a dispensing port at the opened end. The package may have a fluid barrier configured to maintain the port and vent in an aseptic state while the packaging system is in a closed state.

Alternatively, the high barrier container secondary package may be formed as a collapsible shell. Such a collapsible shell may be made of a flexible or semi-flexible material, or may be formed of rigid material and configured to collapse as in a barrel-and-plunger arrangement. The high barrier package further comprises a collapsible inner vessel comprising the storage volume for the perishable agent or drug product, and a dispensing port. In this case, the ports may be joined to the collapsible inner package and provide a fluid connection thereto. The ports may be maintained in an aseptic state after sterile fill by enclosure within a sterile barrier or label, or enclosure of the whole package with such a barrier, or by control of the environment surrounding the package.

The primary package can deplete its volume in order to draw a dose, and the depletion may generally avoid compromising the sterility of the fluid pathway for the beneficial agent. Depletion may be accomplished by the addition of air to the secondary package via the port. Variations designed for such use may not employ a vent, although this remains an option.

For versions of the packaging system comprising a flexible or semi-flexible secondary package, the secondary package may generally allow for withdrawal without the addition of air. This outer packaging provide for pressure equalization between the ambient environment and the secondary volume by flexing, or by way of a vent or permeable membrane as discussed for packing systems with a rigid or semi-rigid secondary package.

In variations comprising a rigid secondary package, an attempt to withdraw the stored contents without the addition of air may draw a vacuum in the secondary volume between the primary package and the secondary package. This pressure differential may impede depletion, withdrawal, and administration of a stored beneficial agent. When employing a vent for pressure equilibration, there is a great deal of flexibility in arranging the vent based on the needs of the particular mode of the packaging system. A vent can be included in the secondary package, in the rigid section of the molded component, and/or as a part of the dispensing port.

The dispensing port itself may protrude from the secondary package, or may be disposed wholly within, or may be integrally formed to join with the inner and outer package and establish a tight seal across the opening area. If wide compatibility with other medical devices and systems is desirable, the dispensing port can include a connector like a luer-lock or luer slip connector, a fluid transfer needle, or a cannula, or some other connecting system. In general, such compatibility is highly desirable.

The geometry of the packaging system may also be modified for factors such as packing efficiency, stability in storage, shock and drop resistance, or other packaging engineering requirements.

### BRIEF DESCRIPTION OF THE FIGURES

FIG. 1a-c show external and cross-section views of a packaging system with a cap and a vent.

FIGS. 2a-b show cross-sections of a packaging system with a vent closable by a cap.

FIG. 3a-b show cross-sections of a packaging system with a flexible secondary package.

FIG. 4a-b show cross-sections of a packaging system with a breakaway fluid barrier.

FIG. 5 shows a cross-section of a packaging system with a polygonal secondary package.

### DETAILED DESCRIPTION OF THE INVENTION

Several aseptic packages for storing injectable medications are commercially available. Perhaps the most common aseptic package for injectable products is glass vials. Some medications are stored in separate vials and are mixed just prior to use. Often this is done to improve the medication's stability or to extend the medication's shelf life. In one example, the medication is a vaccine that is kept dry in one vial to extend the vaccine thermo stability, and a companion vial stores a diluent that is dispensed to the vaccine vial via a syringe and needle prior to injection. In another example, the medication is a vaccine where one vial stores the formulated antigen and a second vial stores an adjuvant.

Several existing products include a flexible package made from film or foils in which a product can be stored in an aseptic manner until the time of use. Some of these products further include a dispensing port communicating with the product in the dispensing package. In some cases, a rupturable barrier is present between the port and the product to enhance the integrity of the package until the time of use. These flexible packages may comprise at least two product compartments that are mergeable prior to use to allow the substances from the different compartments to mix and form the dispensable product. In some cases, these packages are made from a film or a foil (together referred to as webs or web walls) where a first web wall is sealed to a second web wall to define the boundaries of a product compartment. These packages are sometimes referred to as bags, blisters, pouches or sachets. Packages for drugs, pharmaceutical agents or other beneficial agents are sometimes referred to as containers, primary containers, and container-closure systems.

For pharmaceutical products, and particularly for sterile products that are administered parenteral such as by intravenous (IV) infusion and injection, rigorous measures are taken to prevent contamination, foreign biologic matter, and foreign particulates from entering the container. In several cases, the pharmaceutical ingredient cannot be sterilized after filling, hence the filling process is executed using pre-sterilized packages in a controlled clean environment. Several types of filling systems incorporate the steps of receiving open packages, washing, drying, sterilizing, and inspecting the packages prior to filling. After filling, the packages are sealed, still in the controlled environment, by joining the walls of the package or by introducing a closure to the package.

After sterile fill, the sterility of such pharmaceutical products must generally be maintained through packaging, warehousing, distribution, and on-site storage at the destination pharmacy, clinic, hospital or other healthcare setting. Sterility must be maintained under a wide array of external environments, including variation in outside temperature, humidity, air pressure, vibration, cleanliness, sterility and courier handling. Such packaging must facilitate stability of the stored beneficial agent, drug, or other compound in whatever form or physical state may be required, such as a dissolved or suspended agent, or a dry form for reconstitution, or a flowable dry form, or a form suspended in a cream or ointment such as for topical, otic, ocular or other uses. Certain types of pharmaceuticals such as vaccines present particular distribution challenges. These challenges may include sensitivity to silicone lubricants or other materials associated with storage in syringes or their equivalents, low packaging efficiency and challenging stability requirements during transport leading to increased logistical costs, and the number of steps involved in withdrawal, preparation, and administration introducing complexity and a risk of human error into such processes.

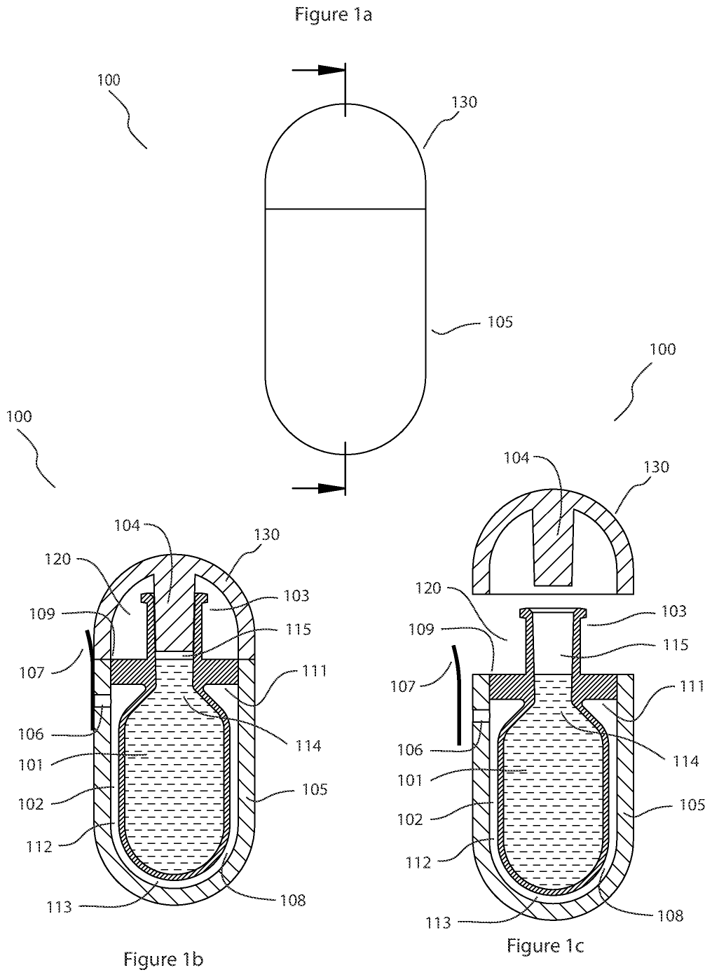

FIGS. 1a-c illustrate an example of a packaging system 100 for storing a beneficial agent. FIG. 1a shows an external view of an exemplary packaging system comprising a removable cap 130 and the secondary package 105. The illustration indicates an axis of symmetry, which may variously form a planar, rotational or cross-sectional axis of symmetry in different examples. As show in this and other examples, certain features such as a vent 106 or a seal 107 may not follow this general symmetry, although the whole packaging system 100 may remain substantially symmetric. FIG. 1b illustrates the packaging system 100 in a closed state, aka a first state. FIG. 1c illustrates the packaging system 100 in an open state, aka a second state, where both a dispensing port 103 and a vent 106 are open to the ambient environment. Depending on the mode of practice, the packaging system may also exist in an intermediate state where one or the other fluid channel is open.

The packaging system 100 may include a primary package 102 configured to connect to a secondary package 105. The primary package 102 may include a storage volume 101 configured to contain a beneficial agent, e.g. a pharmaceutical or biological medication. The primary package 102 comprises compartment 112 with a closed end 113 and an open end 114 which may be in fluid communication with a fluid channel 115 disposed within a dispensing port 103. The primary package 102 may be configured to flex to dispense the contents of the storage volume 101 through the dispensing port 103 when the packaging system 100 is in an opened state. The primary package 102 may include a rigid section 111 with a flange extending outward from the fluid channel 115 and configured to connect to the secondary package 105 at a sealing surface 109. The primary package 102 may incorporate a web material comprising a polymer layer, a siliconized layer providing a high oxygen barrier, and/or a film or foil layer. Optionally, the primary package 102 may comprise a monolayer polymer web. The secondary package 105 can provide a barrier to restrict ingress of contaminants such as moisture and gas into the secondary volume 108. The secondary package 105 may include a vent 106 with a removable seal 107, and the dispensing port 103 may likewise include a removable seal 104, herein comprising an element a cap 130. As shown, the seal 104 may be formed as a rod configured to extend into the fluid channel 115 when the packaging system 100 is in the closed state of FIG. 1a-b. The seal 104 may be configured to seal a luer connection or other such medical device connectors.

The rigid section 111 may comprise the same material as a sidewall of the primary package 102 containing the storage volume 101. The rigidity of the rigid section 111 may be achieved by use of a thickened portion of the material. In this regard, the sidewall of the primary package 102 may be flexible (e.g., substantially more flexible than the rigid section 111) and the rigid section 111 may be rigid (e.g., substantially more rigid than the sidewall of the primary package 102). For example, during normal use of the packaging system 100, the rigid section 111 may not deflect, whereas the sidewall of the primary package 102 may deform or deflect to deplete the storage volume 101 from the primary package 102.

The arrangement of the packaging system 100 may be such that in a first state as shown in FIG. 1b the storage volume 101 and secondary volume 108 are sealed and the secondary package 105 and primary package 102 protect a beneficial agent in the storage volume 101 from infiltration or contamination. The secondary package 105 may specifically prevent contamination by substances able to penetrate the flexible wall of the primary package 102 if the primary package 102 were directly exposed to the ambient environment. The primary package 102 may be formed of a material less reactive with a beneficial agent than the high barrier material of the secondary package 105. In a second state of the packaging system 100, the removable fluid channel seal 104 and removable vent seal 107 may be removed and the storage volume 101 and secondary volume 108 may be opened to fluid communication with the ambient environment. This fluid communication may allow for pressure equilibration between the ambient environment and the internal volumes 101 and 108, which can facilitate the collapse of the primary package 102 and the expulsion of the contents of the storage volume 101 through the dispensing port 103.

The secondary package 105 may optionally be configured as a removable component, and the primary package 102 may be configurable for storage without the outer package. Storage of a packaging system 100 without the secondary package 105 may be facilitated by control of the ambient environmental conditions, such as by controlling ambient temperature, moisture levels, or gas composition. This may be accomplished by using clean room techniques, including ISO standard clean room techniques and their analogous and succeeding standards and methods.

The packaging system 100 may be formed with a molded component 120, which may include the primary package 102, fluid channel 115, a rigid section 111, and/or a dispensing port 103 optionally connected to the rigid section 111. The rigid section 111 may be configured to connect to a secondary package 105 such that the compartment 112 is contained within the secondary volume 108. The rigid section 111 may include a flanged section extending radially outward, and may be configured to connect to the secondary package 105 at least partially by the flanged section. The flanged portion may be configured to connect to a secondary package 105 at a sealing surface 109 that seals a secondary volume 108. The compartment 112 with the flexible wall may be composed of a material substantially inert relative to a substance stored therewithin, including a beneficial agent. As such, the secondary package 105 may be more chemically reactive with the beneficial agent than the flexible wall. The flexible wall itself may be composed of a material less adapted to prevent ingress of spoiling elements when compared to a high barrier material used in the secondary package.

The molded component 120 may incorporate a dispensing port 103 through which a beneficial agent contained in the storage volume 101 can be expelled. The molded component 120 may be a co-molded component formed of a first material and a second material, the first material being molded into a form and joined to a second material. As shown, the rigid section 111 may be molded from the first material along with the dispensing port 103 and sealing surface 109. The compartment 112 may be the second co-molded material joined to the first material. The molded component 120 may optionally be a unitary molded component which consists of one material, in which case the rigid section 111 and the compartment 112 may be a single material as noted above. Whether co-molded or unitary, the molded component may be formed by blow-molding, injection molding, injection blow-molding, or an equivalent molding processes, and may include any of polypropylene, polyethylene, cyclic olefin polymer, and/or cyclic olefin copolymer.

The rigid section 111 of the molded component 120 may provide a fluid barrier between a secondary volume 108 within the secondary package 105 and an external environment. The rigid section 111 may have a flange extending radially outward from a fluid channel 115, the fluid channel 115 providing fluid communication from the storage volume 101 to the dispensing port 103 and/or an external environment. A cross-section of the flange may form a circular, rectangular, or polygonal geometry. The extent of fluid communication provided by the fluid channel 115 may depend on the state of the packaging system 100; in the closed state a cap, cover, strap, or label such as the seal 104 may prevent fluid communication to the dispensing port 103 and/or the external environment, while in the opened state the fluid barrier may be removed to allow expulsion through the fluid channel 115.

The arrangement of the secondary package 105 may be such that pressure equilibrates between the secondary volume 108 and an ambient pressure. This can be accomplished by including a vent 106 which selectively provides fluid communication between the internal volume of the secondary package 105 and an ambient environment, or by manufacture of the secondary package 105 from a permeable material permeable to gases or other fluids. As shown, the vent 106 is disposed in the secondary package 105 and covered by a seal 107 providing a fluid barrier in the closed state. Optionally, a vent may be disposed in the rigid section of the molded component. A vent may provide a venting pathway configured for fluid communication between the secondary volume 108 and an external environment when the packaging system 100 is in an open state with a fluid barrier removed. Such pressure equilibration may be controlled by optionally including a cover, strap, label or the equivalent impermeable barrier over a part or the whole of the secondary package 105. An impermeable barrier may be applied to prevent pressure equilibration when the packaging system 100 is in a storage state for long-term storage of the contents therein, including for long term storage of a beneficial agent. An impermeable barrier may be applied to the packaging system during manufacturing and/or after a fill operation, and may be removable by a user prior to dispensing the contents of the storage volume 101. The secondary package 105 may be rigid, as with the rigid section 111 of the molded component 120, or flexible similar to the flexible wall of the compartment 112. As such, the secondary package 105 may include a molded polymer and/or a web material as described.

The flexible sidewall of the compartment 112 may be configured to collapse to deplete a beneficial agent from the storage volume 101 through a dispensing port 103. The flexible sidewall may include a web material including a monolayer web or multilayer web, and may incorporate a film, a foil, an adhesive, a polymer layer, a metallic layer, and/or a metal oxide layer. As examples of their respective materials classes, a polymer layer may be formed polypropylene, polyethylene, cyclic olefin polymer, and/or cyclic olefin copolymer, a metallic layer may include aluminum or alloys thereof, and a metal oxide layer could include silicon oxide and/or aluminum oxide.

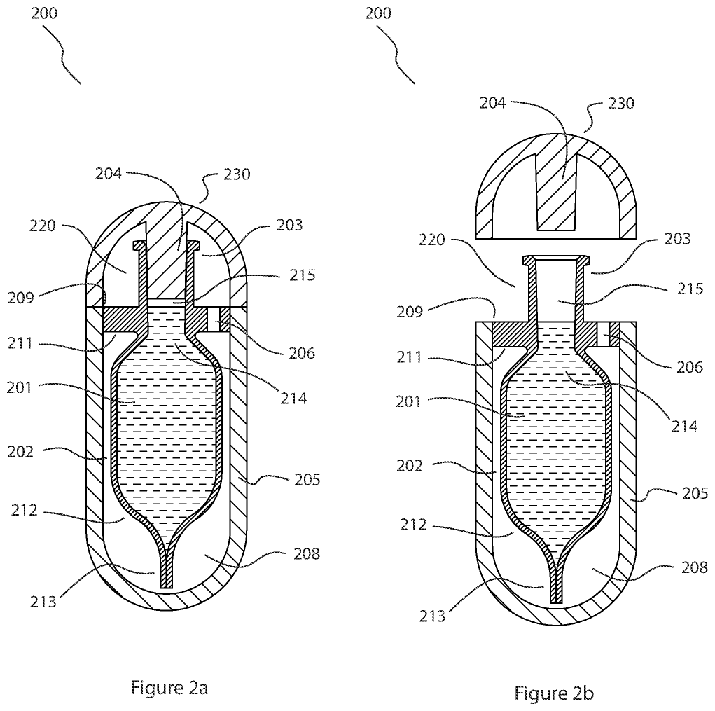

FIGS. 2a-b illustrate a packaging system 200 for storing a beneficial agent. FIG. 2a illustrates the packaging system 200 in a closed state, aka a first state, wherein a cap 230 provides a fluid barrier between a fluid channel 215, a vent 206, and the ambient environment. FIG. 2b illustrates the packaging system 200 in an open state, aka a second state, where both a dispensing port 203 and a vent 206 are open to the ambient environment. Depending on the mode of practice, the packaging system may also exist in an intermediate state where one or the other fluid channel is open.

The packaging system 200 includes a primary package 202 configured to connect to a secondary package 205. The primary package 202 includes a storage volume 201 configured to contain a beneficial agent, e.g. a pharmaceutical or biological medication. The primary package 202 comprises compartment 212 with a sealed end 213 and an open end 214 which may be in fluid communication with a fluid channel 215 disposed within a dispensing port 203. The primary package 202 may be configured to flex to dispense the contents of the storage volume 201 through the dispensing port 203 when the packaging system 200 is in an opened state. The primary package 202 may include a rigid section 211 with a flange extending outward from the fluid channel 215 and configured to connect to the secondary package 205 at a sealing surface 209. The primary package 202 may incorporate a web material comprising a polymer layer, a siliconized layer providing a high oxygen barrier, and/or a film or foil layer. Optionally, the primary package 202 may comprise a monolayer polymer web. The secondary package 205 can provide a barrier to restrict ingress of contaminants such as moisture and gas into the secondary volume 208. The molded component 220 may include a vent 206 closeable by a removable fluid barrier such as the cap 230, and the dispensing port 203 may likewise be closeable by a removable fluid barrier such as the cap 230. As shown, the seal 204 may be formed as a rod configured to extend into the fluid channel 215 when the packaging system 200 is in the closed state of FIG. 2a. The seal 204 may be configured to seal a luer connection or other such medical device connectors.

The rigid section 211 may comprise the same material as a sidewall of the primary package 202 containing the storage volume 201. The rigidity of the rigid section 211 may be achieved by use of a thickened portion of the material. In this regard, the sidewall of the primary package 202 may be flexible (e.g., substantially more flexible than the rigid section 211) and the rigid section 211 may be rigid (e.g., substantially more rigid than the sidewall of the primary package 202). For example, during normal use of the packaging system 200, the rigid section 211 may not deflect, whereas the sidewall of the primary package 202 may deform or deflect to deplete the storage volume 201 from the primary package 202 through fluid channel 215 of the dispensing port 203.

The arrangement of the packaging system 200 may be such that in a first state as shown in FIG. 2a the storage volume 201 and secondary volume 208 are sealed and the secondary package 205 and primary package 202 protect a beneficial agent in the storage volume 201 from infiltration or contamination. The secondary package 205 may specifically prevent contamination by substances able to penetrate the flexible wall of the primary package 202 if the primary package 202 were directly exposed to the ambient environment. The primary package 202 may be formed of a material less reactive with a beneficial agent than the high barrier material of the secondary package 205. In a second state of the packaging system 200, the removable fluid channel seal 204 may be removed and the storage volume 201 and secondary volume 208 may be opened to fluid communication with the ambient environment. This fluid communication may allow for pressure equilibration between the ambient environment and the internal volumes 201 and 208, which can facilitate the collapse of the primary package 202 and the expulsion of the contents of the storage volume 201 through the dispensing port 203.

The secondary package 205 may optionally be configured as a removable component, and the primary package 202 may be configurable for storage without the outer package. Storage of a packaging system 200 without the secondary package 205 may be facilitated by control of the ambient environmental conditions, such as by controlling ambient temperature, moisture levels, or gas composition. This may be accomplished by using clean room techniques, including ISO standard clean room techniques and their analogous and succeeding standards and methods.

The packaging system 200 may be formed with a molded component 220, which may include the primary package 202, fluid channel 215, a rigid section 211, and/or a dispensing port 203 optionally connected to the rigid section 211. The rigid section 211 may be configured to connect to a secondary package 205 such that the compartment 212 is contained within the secondary volume 208. The rigid section 211 may include a flanged section extending radially outward, and may be configured to connect to the secondary package 205 at least partially by the flanged section. The flanged portion may be configured to connect to a secondary package 205 with a sealing surface 209 that seals a secondary volume 208. The compartment 212 with the flexible wall may be composed of a material substantially inert relative to a substance stored therewithin, including a beneficial agent. As such, the secondary package 205 may be more chemically reactive with the beneficial agent than the flexible wall. The flexible wall itself may be composed of a material less adapted to prevent ingress of spoiling elements when compared to a high barrier material used in the secondary package.

The molded component 220 may incorporate a dispensing port 203 through which a beneficial agent contained in the storage volume 201 can be expelled. The molded component 220 may be a co-molded component formed of a first material and a second material, the first material being molded into a form and joined to a second material. As shown, the rigid section 211 may be molded from the first material along with the dispensing port 203 and sealing surface 209. The compartment 212 may be the second co-molded material joined to the first material. The molded component 220 may optionally be a unitary molded component which consists of one material, in which case the rigid section 211 and the compartment 212 may be a single material. Whether co-molded or unitary, the molded component may be formed by blow-molding, injection molding, injection blow-molding, or an equivalent molding processes, and may include any of polypropylene, polyethylene, cyclic olefin polymer, and/or cyclic olefin copolymer.

The rigid section 211 of the molded component 220 may provide a fluid barrier between a secondary volume 208 within the secondary package 205 and an external environment. The rigid section 211 may have a flange extending radially outward from a fluid channel 215, the fluid channel 215 providing fluid communication from the storage volume 201 to the dispensing port 203 and/or an external environment. A cross-section of the flange may form a circular, rectangular, or polygonal geometry. The extent of fluid communication provided by the fluid channel 215 may depend on the state of the packaging system 200; in the closed state a cap, cover, strap, or label such as the seal 204 may prevent fluid communication to the dispensing port 203 and/or the external environment, while in the opened state the fluid barrier may be removed to allow expulsion through the fluid channel 215.

The arrangement of the secondary package 205 may be such that pressure equilibrates between the secondary volume 208 and an ambient pressure. This can be accomplished by including a vent 206 which selectively provides fluid communication between the internal volume of the secondary package 205 and an ambient environment, selective responsive to the removal of a fluid barrier. Alternatively, this may be accomplished by manufacture of the secondary package 205 from a permeable material permeable to gases or other fluids or from a flexible material. As shown, the vent 206 is disposed in the molded component 220 and closed by a cap 230 providing the fluid barrier in the closed state. Optionally, a vent may be disposed in the rigid section 211 of the molded component as shown. A vent 206 may provide a venting pathway configured for fluid communication between the secondary volume 208 and an external environment when the packaging system 200 is in an open state with a fluid barrier removed.

Such pressure equilibration may be controlled by optionally including a cover, strap, label or the equivalent impermeable barrier over a part or the whole of the secondary package 205. An impermeable barrier may be applied to prevent pressure equilibration when the packaging system 200 is in a storage state for long-term storage of the contents therein, including for long term storage of a beneficial agent. An impermeable barrier may be applied to the packaging system during manufacturing and/or after a fill operation, and may be removable by a user prior to dispensing the contents of the storage volume 201. The secondary package 205 may be rigid, as with the rigid section 211 of the molded component 220, or flexible similar to the flexible wall of the compartment 212. As such, the secondary package 205 may include a molded polymer and/or a web material as described.

The ambient pressure with which the pressure in the storage volume 201 and/or secondary volume 208 equilibrates in the open state may be the pressure of any environment external to the packaging system, such as open atmosphere or the pressure within a pressure chamber upon activation of a pressure driven beneficial agent administration system as taught in U.S. Pat. Nos. 10,716,901 and/or 11,638,794, or a pressure external to such dispensing devices. Equilibration of pressure may be selective, meaning that an elevated pressure in a pressure chamber as taught in the referenced U.S. patents may communication through the vent 206 in the open state, but not through the dispensing port 203. This selectivity may provide for pressure driven dispensing of the contents of the storage volume 201 through the dispensing port 203. In principle, such selectivity may be employed in a wide range of modes of the invention including many of those of FIGS. 1-5.

The flexible wall of the compartment 212 may be configured to collapse to deplete a beneficial agent from the storage volume 201 through a dispensing port 203. The flexible wall may include a web material including a monolayer web or multilayer web, and may incorporate a film, a foil, an adhesive, a polymer layer, a metallic layer, and/or a metal oxide layer. As examples of their respective materials classes, a polymer layer may be formed polypropylene, polyethylene, cyclic olefin polymer, and/or cyclic olefin copolymer, a metallic layer may include aluminum or alloys thereof, and a metal oxide layer could include silicon oxide and/or aluminum oxide.

The primary package 202 may further include a sealed end 213, which may be sealed against itself as by heat sealing or an equivalent process. Such a configuration and process may allow for a fluid barrier to close the dispensing port 203 prior to a fill operation. This may provide for aseptic integration of a fluid barrier to the rigid section 211. This may be advantageous for the manufacturing process of packaging systems for some beneficial agents. The sealed end 213 may provide a fluid barrier preventing fluid communication between the storage volume 201 of the compartment 212 and the secondary volume 208 of the secondary package 205. In some variations, the sealed end 213 can be sealed with a beneficial agent contained in the storage volume, i.e. a fill-seal process. The primary package 202 also includes an open end 214 configured to allow fluid communication from the storage volume 201 to the dispensing port 203 through the fluid channel 215 when the packaging system is in an opened state.

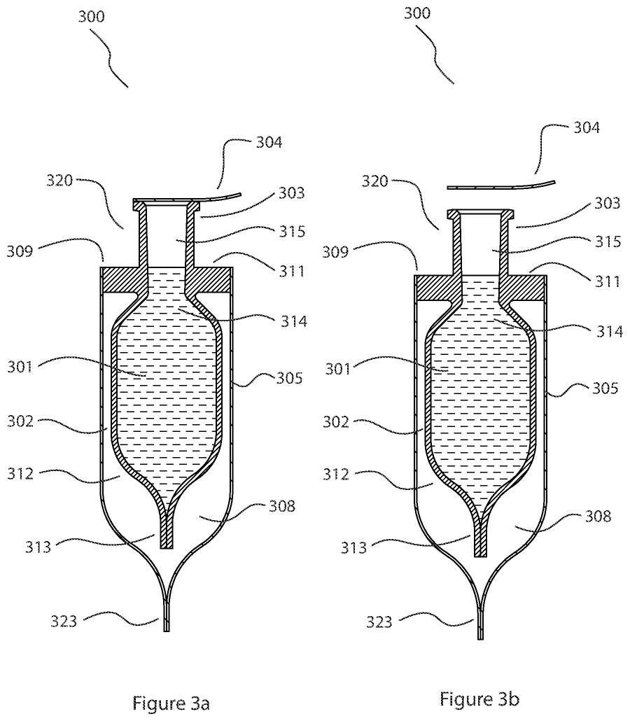

FIGS. 3a-b illustrate a packaging system 300 for storing a beneficial agent and comprising a flexible secondary package 305. FIG. 3a illustrates the packaging system 300 in a closed state, aka a first state, wherein a seal 304 provides a fluid barrier between a fluid channel 315 and the ambient environment. FIG. 3b illustrates the packaging system 300 in an open state, aka a second state, where the dispensing port 303 is open to ambient.

The packaging system 300 includes a primary package 302 configured to connect to a secondary package 305. The primary package 302 includes a storage volume 301 configured to contain a beneficial agent, e.g. a pharmaceutical or biological medication. The primary package 302 comprises compartment 312 with a sealed end 313 and an open end 314 which may be in fluid communication with a fluid channel 315 disposed within a dispensing port 303. The primary package 302 may be configured to flex to dispense the contents of the storage volume 301 through the dispensing port 303 when the packaging system 300 is in an opened state. The primary package 302 may include a rigid section 311 with a flange extending outward from the fluid channel 315 and configured to connect to the secondary package 305 at a sealing surface 309. The primary package 302 may incorporate a web material comprising a polymer layer, a siliconized layer providing a high oxygen barrier, and/or a film or foil layer. Optionally, the primary package 302 may comprise a monolayer polymer web. The secondary package 305 can provide a barrier to restrict ingress of contaminants such as moisture and gas into the secondary volume 308, and may comprise a sealed end 323 sealed against itself as by heat sealing. This may be advantageous for efficient manufacture of the packaging system by a fill-seal operation wherein sealing of the dispensing port 303 and sterilization of the packaging system 300 precedes filling the storage volume 301 with a beneficial agent, followed by sealing of the sealed end 313 and sealed end 323. The molded component 320 may include a vent closeable by a removable fluid barrier, and the dispensing port 303 may likewise be closeable by a removable fluid barrier such as the seal 304. As shown, the seal 304 may cover the exterior of the fluid channel 315. The seal 304 may be configured to seal any dispensing port 303 such as a luer connection or other such medical device connector.

The arrangement of the packaging system 300 may be such that in a first state as shown in FIG. 3a the storage volume 301 and secondary volume 308 are sealed and the secondary package 305 and primary package 302 protect a beneficial agent in the storage volume 301 from infiltration or contamination. The secondary package 305 may specifically prevent contamination by substances able to penetrate the flexible wall of the primary package 302 if the primary package 302 were directly exposed to the ambient environment. The primary package 302 may be formed of a material less reactive with a beneficial agent than the high barrier material of the secondary package 305. In a second state of the packaging system 300, the removable fluid channel seal 304 may be removed and the storage volume 301 may be opened to fluid communication with the ambient environment. This fluid communication may allow for pressure equilibration between the ambient environment and the internal volumes 301 and 308 due to the flexibility of primary package 302 and secondary package 305, which can facilitate the collapse of the primary package 302 and the expulsion of the contents of the storage volume 301 through the dispensing port 303.

The secondary package 305 may optionally be configured as a removable component, and the primary package 302 may be configurable for storage without the outer package. Storage of a packaging system 300 without the secondary package 305 may be facilitated by control of the ambient environmental conditions, such as by controlling ambient temperature, moisture levels, or gas composition. This may be accomplished by using clean room techniques, including ISO standard clean room techniques and their analogous and succeeding standards and methods.

The packaging system 300 may be formed with a molded component 320, which may include the primary package 302, fluid channel 315, a rigid section 311, and/or a dispensing port 303 optionally connected to the rigid section 311. The rigid section 311 may be configured to connect to a secondary package 305 such that the compartment 312 is contained within the secondary volume 308. The rigid section 311 may include a flanged section extending radially outward, and may be configured to connect to the secondary package 305 at least partially by the flanged section. The flanged portion may be configured to connect to a secondary package 305 with a sealing surface 309 that seals a secondary volume. The compartment 312 with the flexible wall may be composed of a material substantially inert relative to a substance stored therewithin, including a beneficial agent. As such, the secondary package 305 may be more chemically reactive with the beneficial agent than the flexible wall. The flexible wall itself may be composed of a material less adapted to prevent ingress of spoiling elements when compared to a high barrier material used in the secondary package.

The molded component 320 may incorporate a dispensing port 303 through which a beneficial agent contained in the storage volume 301 can be expelled. The molded component 320 may be a co-molded component formed of a first material and a second material, the first material being molded into a form and joined to a second material. As shown, the rigid section 311 may be molded from the first material along with the dispensing port 303 and sealing surface 309. The compartment 312 may be the second co-molded material joined to the first material. The molded component 320 may optionally be a unitary molded component which consists of one material, in which case the rigid section 311 and the compartment 312 may be a single material. Whether co-molded or unitary, the molded component may be formed by blow-molding, injection molding, injection blow-molding, or an equivalent molding processes, and may include any of polypropylene, polyethylene, cyclic olefin polymer, and/or cyclic olefin copolymer. In some variations of the disclosed embodiments, these process may be used to form the secondary package alone or in combination with their use to form the primary package.

The rigid section 311 of the molded component 320 may provide a fluid barrier between a secondary volume 308 within the secondary package 305 and an external environment. The rigid section 311 may have a flange extending radially outward from a fluid channel 315, the fluid channel 315 providing fluid communication from the storage volume 301 to the dispensing port 303 and/or an external environment. A cross-section of the flange may form a circular, rectangular, or polygonal geometry. The extent of fluid communication provided by the fluid channel 315 may depend on the state of the packaging system 300; in the closed state a cap, cover, strap, or label such as the seal 304 may prevent fluid communication to the dispensing port 303 and/or the external environment, while in the opened state the fluid barrier may be removed to allow expulsion through the fluid channel 315.

The rigid section 311 may comprise the same material as a sidewall of the primary package 302 containing the storage volume 301. The rigidity of the rigid section 311 may be achieved by use of a thickened portion of the material. In this regard, the sidewall of the primary package 302 may be flexible (e.g., substantially more flexible than the rigid section 311) and the rigid section 311 may be rigid (e.g., substantially more rigid than the sidewall of the primary package 302). For example, during normal use of the packaging system 300, the rigid section 311 may not deflect, whereas the sidewall of the primary package 302 may deform or deflect to deplete the storage volume 301 from the primary package 302 through fluid channel 315 of the dispensing port 303.

The arrangement of the secondary package 305 may be such that pressure equilibrates between the secondary volume 308 and an ambient pressure. This can be accomplished by including a vent which selectively provides fluid communication between the internal volume of the secondary package 305 and an ambient environment, selective responsive to the removal of a fluid barrier. Alternatively, this may be accomplished by manufacture of the secondary package 305 from a permeable material permeable to gases or other fluids, or from a flexible material as described for the manufacture of the primary package 302. As shown, the flexible secondary package 305 may be configured to connect to the molded component 320 and sealed against the ambient environment by a rigid section 311, including a flanged rigid section 311. This may provide the fluid barrier to isolate the secondary volume 308 in the closed state and the fluid barrier may not need to be removed in the open state. Conceptually, this may allow for the 308 to be filled with a selected gas or fluid to further protect a stored beneficial agent in the storage volume 301.

While a vent as elsewhere herein described may be provided, it may also be omitted entirely. Pressure equilibration may be controllable by a fluid barrier such as the seal 304, without need for a vent. An impermeable barrier and positive or negative internal pressure in the storage volume 301 may be provided to prevent pressure equilibration when the packaging system 300 is in a storage state for long-term storage of the contents therein, including for long term storage of a beneficial agent. An impermeable barrier may be applied to the packaging system during manufacturing and/or after a fill operation, and may be removable by a user prior to dispensing the contents of the storage volume 301. The secondary package 305 may be rigid, as with the rigid section 311 of the molded component 320, or flexible similar to the flexible wall of the compartment 312. As such, the secondary package 305 may include a molded polymer and/or a web material as described.

The flexible wall of the compartment 312 may be configured to collapse to deplete a beneficial agent from the storage volume 301 through a dispensing port 303. The flexible wall may include a web material including a monolayer web or multilayer web, and may incorporate a film, a foil, an adhesive, a polymer layer, a metallic layer, and/or a metal oxide layer. As examples of their respective materials classes, a polymer layer may be formed polypropylene, polyethylene, cyclic olefin polymer, and/or cyclic olefin copolymer, a metallic layer may include aluminum or alloys thereof, and a metal oxide layer could include silicon oxide and/or aluminum oxide.

The primary package 302 may include a sealed end 313 and the secondary package 305 may likewise have a sealed end 323, which sealed ends may be sealed against themselves respectively as by heat sealing or an equivalent process. Conceptually, the sealed end 313 and open end 314 may even be sealed against each other in some modes of the invention. This may be practiced to provide additional structural integrity to a packaging system 300 or for ease of manufacturing. Such a configuration and process may allow for a fluid barrier to close the dispensing port 303 prior to a fill operation. This may provide for aseptic integration of a fluid barrier to the rigid section 311. This may be advantageous for the manufacturing process of packaging systems for some beneficial agents. The sealed end 313 may provide a fluid barrier preventing fluid communication between the storage volume 301 of the compartment 312 and the secondary volume 308 of the secondary package 305. In some variations, the sealed end 313 can be sealed with a beneficial agent contained in the storage volume, i.e. a fill-seal process. The primary package 302 also includes an open end 314 configured to allow fluid communication from the storage volume 301 to the dispensing port 303 through the fluid channel 315 when the packaging system is in an opened state.

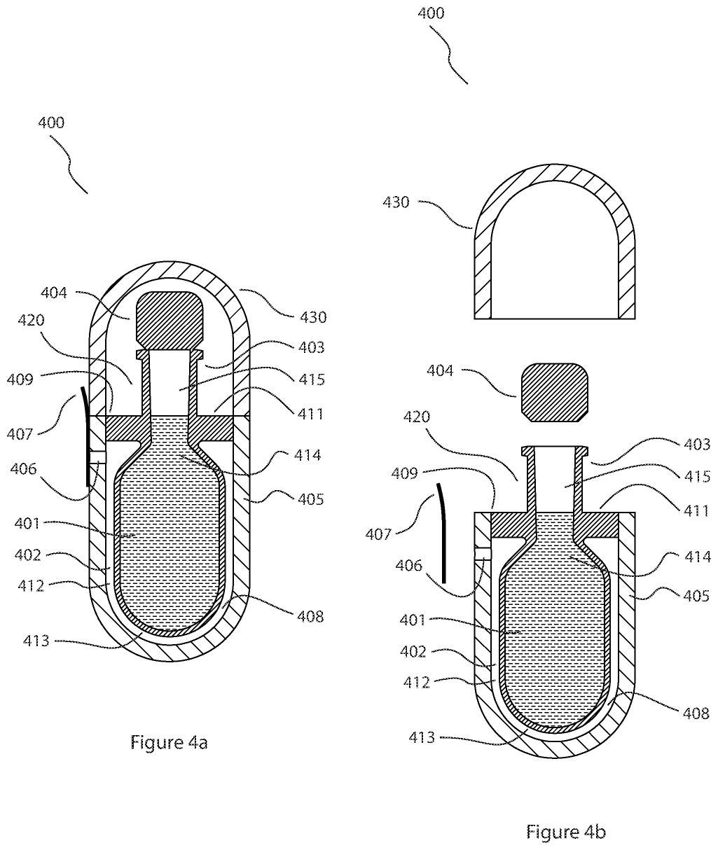

FIGS. 4a-b illustrate a packaging system 400 for storing a beneficial agent. FIG. 4a illustrates the packaging system 400 in a closed state, aka a first state, wherein a cap 430 and a breakaway section 404 provide a fluid barrier between a fluid channel 415 and the ambient environment. FIG. 4b illustrates the packaging system 400 in an open state, aka a second state, where both a dispensing port 403 and a vent 406 are open to the ambient environment and the fluid channel 415 provides a fluid pathway. Depending on the mode of practice, the packaging system may also exist in an intermediate state where one or the other fluid pathway is open.

The packaging system 400 includes a primary package 402 configured to connect to a secondary package 405. The primary package 402 includes a storage volume 401 configured to contain a beneficial agent, e.g. a pharmaceutical or biological medication. The primary package 402 comprises compartment 412 with a closed end 413 and an open end 414 which may be in fluid communication with a fluid channel 415 disposed within a dispensing port 403. The primary package 402 may be configured to flex to dispense the contents of the storage volume 401 through the dispensing port 403 when the packaging system 400 is in an opened state. The primary package 402 may include a rigid section 411 with a flange extending outward from the fluid channel 415 and configured to connect to the secondary package 405 at a sealing surface 409. The primary package 402 may incorporate a web material comprising a polymer layer, a siliconized layer providing a high oxygen barrier, and/or a film or foil layer. Optionally, the primary package 402 may comprise a monolayer polymer web. The secondary package 405 can provide a barrier to restrict ingress of contaminants such as moisture and gas into the secondary volume 408. The molded component 420 may include a vent 406 closeable by a removable fluid barrier such as the cap 430, and the dispensing port 403 may likewise be closeable by a removable fluid barrier such as the cap 430. As shown, the breakaway section 404 may be configured as a molded piece joined to the molded component 420 in the closed state of FIG. 4a. The breakaway section 404 may be configured to seal a luer connection or other such medical device connectors.

The arrangement of the packaging system 400 may be such that in a first state as shown in FIG. 4a the storage volume 401 and secondary volume 408 are sealed and the secondary package 405 and primary package 402 protect a beneficial agent in the storage volume 401 from infiltration or contamination. The secondary package 405 may specifically prevent contamination by substances able to penetrate the flexible wall of the primary package 402 if the primary package 402 were directly exposed to the ambient environment. The primary package 402 may be formed of a material less reactive with a beneficial agent than the high barrier material of the secondary package 405. In a second state of the packaging system 400, the breakaway section 404 and removable vent seal 407 may be removed and the storage volume 401 and secondary volume 408 may be opened to fluid communication with the ambient environment. This fluid communication may allow for pressure equilibration between the ambient environment and the internal volumes 401 and 408, which can facilitate the collapse of the primary package 402 and the expulsion of the contents of the storage volume 401 through the dispensing port 403.

The secondary package 405 may optionally be configured as a removable component, and the primary package 402 may be configurable for storage without the outer package. Storage of a packaging system 400 without the secondary package 405 may be facilitated by control of the ambient environmental conditions, such as by controlling ambient temperature, moisture levels, or gas composition. This may be accomplished by using clean room techniques, including ISO standard clean room techniques and their analogous and succeeding standards and methods.

The packaging system 400 may be formed with a molded component 420, which may include the primary package 402, fluid channel 415, a rigid section 411, a fluid barrier such as the breakaway section 404 and/or a dispensing port 403 optionally connected to the rigid section 411. The rigid section 411 may be configured to connect to a secondary package 405 such that the compartment 412 is disposed within the secondary volume 408. The rigid section 411 may include a flanged section extending radially outward, and may be configured to connect to the secondary package 405 at least partially by the flanged section. The flanged portion may be configured to connect to a secondary package 405 with a sealing surface 409 that seals a secondary volume 408. The compartment 412 with the flexible wall may be composed of a material substantially inert relative to a substance stored therewithin, such as a beneficial agent. As such, the secondary package 405 may be more chemically reactive with the beneficial agent than the flexible wall. The flexible wall itself may be composed of a material less adapted to prevent ingress of spoiling elements when compared to a high barrier material used in the secondary package.

The molded component 420 may incorporate a dispensing port 403 through which a beneficial agent contained in the storage volume 401 can be expelled. The molded component 420 may be a co-molded component formed of a first material and a second material, the first material being molded into a form and joined to a second material. As shown, the rigid section 411 may be molded from the first material along with the dispensing port 403, a fluid barrier such as the breakaway section 404 and a sealing surface 409. The compartment 412 may be the second co-molded material joined to the first material. The molded component 420 may optionally be a unitary molded component which consists of one material, in which case the rigid section 411 and the compartment 412 may be a single material. Whether co-molded or unitary, the molded component may be formed by blow-molding, injection molding, injection blow-molding, or an equivalent molding processes, and may include any of polypropylene, polyethylene, cyclic olefin polymer, and/or cyclic olefin copolymer.

The rigid section 411 of the molded component 420 may provide a fluid barrier between a secondary volume 408 within the secondary package 405 and an external environment. The rigid section 411 may have a flange extending radially outward from a fluid channel 415, the fluid channel 415 providing fluid communication from the storage volume 401 to the dispensing port 403 and/or an external environment. A cross-section of the flange may form a circular, rectangular, or polygonal geometry. The extent of fluid communication provided by the fluid channel 415 may depend on the state of the packaging system 400; in the closed state a fluid barrier such as a cap, cover, strap, or label and/or the breakaway section 404 may prevent fluid communication to the dispensing port 403 and/or the external environment, while in the opened state the fluid barrier may be removed to allow expulsion through the fluid channel 415.

The rigid section 411 may comprise the same material as a sidewall of the primary package 402 containing the storage volume 401. The rigidity of the rigid section 411 may be achieved by use of a thickened portion of the material. In this regard, the sidewall of the primary package 402 may be flexible (e.g., substantially more flexible than the rigid section 411) and the rigid section 411 may be rigid (e.g., substantially more rigid than the sidewall of the primary package 402). For example, during normal use of the packaging system 400, the rigid section 411 may not deflect, whereas the sidewall of the primary package 402 may deform or deflect to deplete the storage volume 401 from the primary package 402 through fluid channel 415 of the dispensing port 403.

The arrangement of the secondary package 405 may be such that pressure equilibrates between the secondary volume 408 and an ambient pressure. This can be accomplished by including a vent 406 which selectively provides fluid communication between the internal volume of the secondary package 405 and an ambient environment, selective responsive to the removal of a fluid barrier. Alternatively, this may be accomplished by manufacture of the secondary package 405 from a permeable material permeable to gases or other fluids or from a flexible material. As shown, the vent 406 is disposed in the molded component 420 and closed by a cap 430 providing the fluid barrier in the closed state. Optionally, a vent may be disposed in the rigid section 411 of the molded component as shown. A vent 406 may provide a venting pathway configured for fluid communication between the secondary volume 408 and an external environment when the packaging system 400 is in an open state with a fluid barrier removed. Such pressure equilibration may be controlled by optionally including a breakaway section and/or a cover, strap, label or the equivalent impermeable barrier over a part or the whole of the secondary package 405. An impermeable barrier may be applied to prevent pressure equilibration when the packaging system 400 is in a storage state for long-term storage of the contents therein, including for long term storage of a beneficial agent. An impermeable barrier may be applied to the packaging system during manufacturing and/or after a fill operation, and may be removable by a user prior to dispensing the contents of the storage volume 401. The secondary package 405 may be rigid, as with the rigid section 411 of the molded component 420, or flexible similar to the flexible wall of the compartment 412. As such, the secondary package 405 may include a molded polymer and/or a web material as described.

The flexible wall of the compartment 412 may be configured to collapse to deplete a beneficial agent from the storage volume 401 through a dispensing port 403. The flexible wall may include a web material including a monolayer web or multilayer web, and may incorporate a film, a foil, an adhesive, a polymer layer, a metallic layer, and/or a metal oxide layer. As examples of their respective materials classes, a polymer layer may be formed polypropylene, polyethylene, cyclic olefin polymer, and/or cyclic olefin copolymer, a metallic layer may include aluminum or alloys thereof, and a metal oxide layer could include silicon oxide and/or aluminum oxide.

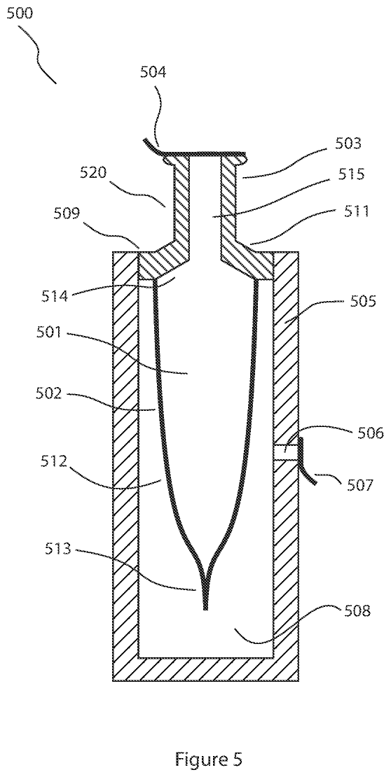

FIG. 5 illustrates a packaging system 500 for storing a beneficial agent. The packaging system 500 includes a primary package 502 configured to connect to a secondary package 505. The primary package 502 includes a storage volume 501 configured to contain a beneficial agent, e.g. a pharmaceutical or biological medication. The primary package 502 comprises a tube with a sealed end 513 where a material is sealed against itself and an open end 514 in fluid communication with a fluid channel 515 in a dispensing port 503. The primary package 502 is configured to flex to dispense the contents of the storage volume 501 through the dispensing port 503 when the packaging system 500 is in an opened state. The primary package 502 may include a rigid section 511 with a flange extending outward from the fluid channel 515 and configured to connect to the secondary package 505 at a sealing surface 509. The primary package 502 may incorporate a web material comprising a polymer layer, a siliconized layer providing a high oxygen barrier, and/or a film or foil layer. Optionally, the primary package 502 may comprise a monolayer polymer web. The secondary package 505 provides a barrier to restrict ingress of contaminants such as moisture and gas into the secondary volume 508. The secondary package 505 may include a vent 506 with a removable seal 507, and the dispensing port 503 may likewise include a removable seal 504. The seals 504 and 507 can be provided by a strap, a label, or by a wrap covering the whole exterior of the packaging system 500.

The arrangement of the packaging system 500 may be such that in a first state the storage volume 501 and secondary volume 508 are sealed and the secondary package 505 and primary package 502 protect a beneficial agent in the storage volume 501 from infiltration or contamination. The secondary package 505 may specifically prevent contamination by substances able to penetrate the flexible wall of the primary package 502 if the primary package 502 were directly exposed to the ambient environment. The primary package 502 may be formed of a material less reactive with a beneficial agent than the high barrier material of the secondary package 505. In a second state of the packaging system 500, the removable seal 504 and removable seal 507 may be removed and the storage volume 501 and secondary volume 508 may be opened to fluid communication with the ambient environment. This fluid communication may allow for pressure equilibration, which can facilitate the collapse of the primary package 502 and the expulsion of the contents of the storage volume 501 through the dispensing port 503.

The secondary package 505 may optionally be configured as a removable component, and the primary package 502 may be configurable for storage without the outer package. Storage of a packaging system 500 without the secondary package 505 may be facilitated by control of the ambient environmental conditions, such as by controlling ambient temperature, moisture levels, or gas composition. This may be accomplished by well known clean room techniques, including ISO standard clean room techniques and their succeeding standards and methods.

The packaging system 500 may be formed with a molded component 520, which may include the primary package 502, fluid channel 515, a rigid section 511, and/or a dispensing port 503 optionally connected to the rigid section 511. The rigid section 511 may be configured to connect to a secondary package 505 such that the compartment 512 is contained within the secondary volume 508. The rigid section 511 may include a flanged section extending radially outward, and may be configured to connect to the secondary package 505 at least partially by the flanged section. The flanged portion may be configured to connect to a secondary package 505 with a sealing surface 509 that seals a secondary volume. The compartment 512 with the flexible wall may be composed of a material substantially inert relative to a substance stored therewithin, including a beneficial agent. As such, the secondary package 505 may be more chemically reactive with the beneficial agent than the flexible wall. The flexible wall itself may be composed of a material less adapted to prevent ingress of spoiling elements when compared to a high barrier material used in the secondary package.

The molded component 520 may incorporate a dispensing port 503 through which a beneficial agent contained in the storage volume 501 can be expelled. The molded component 520 may be a co-molded component formed of a first material and a second material, the first material being molded into a form and joined to a second material. As shown, the rigid section 511 may be molded from the first material along with the dispensing port 503 and sealing surface 509. The compartment 512 may be the second co-molded material joined to the first material. The molded component 520 may optionally be a unitary molded component which consists of one material, in which case the rigid section 511 and the compartment 512 may be a single material. Whether co-molded or unitary, the molded component may be formed by blow-molding, injection molding, injection blow-molding, or an equivalent molding processes, and may include any of polypropylene, polyethylene, cyclic olefin polymer, and/or cyclic olefin copolymer.

The rigid section 511 of the molded component 520 may provide a fluid barrier between a secondary volume 508 within the secondary package 505 and an external environment. The rigid section 511 may have a flange extending radially outward from a fluid channel 515, the fluid channel 515 providing fluid communication from the storage volume 501 to the dispensing port 503 and/or an external environment. A cross-section of the flange may form a circular, rectangular, or polygonal geometry. The extent of fluid communication provided by the fluid channel 515 may depend on the state of the packaging system 500; in the closed state a fluid barrier such as a cap, cover, strap, or label and/or the removable seal 504 may prevent fluid communication to the dispensing port 503 and/or the external environment, while in the opened state the fluid barrier may be removed to allow expulsion through the fluid channel 515.

The arrangement of the secondary package 505 may be such that pressure equilibrates between the secondary volume 508 and an ambient pressure. This can be accomplished by including a vent 506 which selectively provides fluid communication between the internal volume of the secondary package 505 and an ambient environment, or by manufacture of the secondary package 505 from a permeable material permeable to gases or other fluids. Optionally, a vent may be disposed in the rigid section of the molded component. A vent may provide a venting pathway configured for fluid communication between the secondary volume and an external environment when the packaging system 500 is in an open state with a strap or other fluid barrier removed. Such pressure equilibration may be controlled by optionally including a cover, strap, label or the equivalent impermeable barrier over a part or the whole of the secondary package 505. An impermeable barrier may be applied to prevent pressure equilibration when the packaging system 500 is in a storage state for long-term storage of the contents therein, including for long term storage of a beneficial agent. An impermeable barrier may be applied to the packaging system during manufacturing and/or after a fill operation, and may be removable by a user prior to dispensing the contents of the storage volume 501. The secondary package 505 may be rigid, as with the rigid section 511 of the molded component 520, or flexible similar to the flexible wall of the compartment 512. As such, the secondary package 505 may include a molded polymer and/or a web material as described.

The flexible wall of the compartment 512 may be configured to collapse to deplete a beneficial agent from the storage volume 501 through a dispensing port 503. The flexible wall may include a web material including a monolayer web or multilayer web, and may incorporate a film, a foil, an adhesive, a polymer layer, a metallic layer, and/or a metal oxide layer. As examples of their respective materials classes, a polymer layer may be formed polypropylene, polyethylene, cyclic olefin polymer, and/or cyclic olefin copolymer, a metallic layer may include aluminum or alloys thereof, and a metal oxide layer could include silicon oxide and/or aluminum oxide.

The primary package may further include a sealed end 513, which may be sealed against itself as by heat sealing or an equivalent process. Such a configuration and process may allow for a fluid barrier to close the dispensing port 503 prior to a fill operation. This may provide for aseptic integration of a fluid barrier to the rigid section 511. This may be advantageous for the manufacturing process of packaging systems for some beneficial agents. The sealed end 513 may provide a fluid barrier preventing fluid communication between the storage volume 501 enclosed within the compartment 512 and the secondary volume 508 of the secondary package 505. In some variations, the sealed end 513 can be sealed with a beneficial agent contained in the storage volume, i.e. a fill-seal process. The primary package 502 also includes an open end 514 configured to allow fluid communication from the storage volume 501 to the dispensing port 503 through the fluid channel 515 when the packaging system is in an opened state.

In describing and claiming the examples disclosed herein, the singular forms “a”, “an”, and “the” include plural referents unless the context clearly indicates otherwise. Reference throughout the specification to “one variation”, “another embodiment”, “an example”, and so forth, means that a particular element (e.g., feature, structure, and/or characteristic) described in connection with the example is included in at least one example descried herein, and may or may not be present in other examples. In addition, it is to be understood that the described elements for any example may be combined in any suitable manner in various examples unless the context clearly indicates otherwise.

Furthermore, while the technology has been described in language that is specific to certain structures and materials, it is to be understood that the invention defined in the appended claims is not necessarily limited to the specific structures and materials described. Rather, the specific aspects are described as forms of implementing the claimed invention. Specific features of the technology should generally be regarded as optional with respect to each other and with respect to the whole, except where otherwise explicitly noted. Features of one embodiment or set of embodiments should generally be regarded as combinable with features of other embodiments or sets of embodiments, except where otherwise explicitly noted. Because many embodiments of the invention can be practiced without departing from the spirit and scope of the invention, the invention resides solely in the claims.

What is claimed is:

1. A packaging system for storing a beneficial agent comprising:
a primary package including a molded component comprising:
a compartment with a flexible wall enclosing a storage volume configured to store a beneficial agent, and
a rigid section, more rigid relative to the flexible wall, and configured to connect to a secondary package comprising a secondary volume,
wherein the flexible wall is configured to collapse to deplete the storage volume and expel the beneficial agent through a dispensing port.

2. The packaging system of claim 1, wherein the rigid section is configured to connect to the secondary package such that the compartment is disposed within the secondary package and the flexible wall provides a fluid barrier between the storage volume and the secondary volume.

3. The packaging system of claim 1, wherein the secondary package is configured such that pressure equilibrates between the secondary volume and an ambient pressure.

4. The packaging system of claim 1, wherein the molded component includes the dispensing port.

5. The packaging system of claim 4, wherein the dispensing port is configured to allow fluid communication between the storage volume and an external environment when the packaging system is in an opened state.

6. The packaging system of claim 1, wherein the rigid section provides a fluid barrier between the secondary volume and an external environment.

7. The packaging system of claim 1, wherein the molded component comprises a co-molded component.

8. The packaging system of claim 7, wherein the co-molded component is formed of a first material and a second material, the first material being molded into a form and joined to a second material.

9. The packaging system of claim 1, wherein the molded component comprises a unitary molded component.

10. The packaging system of claim 9, wherein the unitary molded component consists substantially of a single material.

11. The packaging system of claim 1, wherein the flexible wall comprises a polymer monolayer.

12. The packaging system of claim 1, wherein the molded component is formed by one of blow-molding, injection molding, or injection blow-molding.

13. The packaging system of claim 1, wherein the secondary package comprises a rigid material.

14. The packaging system of claim 13, wherein the rigid material is a molded polymer.

15. The packaging system of claim 1, wherein the secondary package comprises a web material.

16. The packaging system of claim 15, wherein the web material consists of a monolayer polymer.

17. The packaging system of claim 15, wherein the web material comprises a multilayer structure comprising any of a polymer layer, a metallic layer, or a metal oxide layer.

18. The packaging system of claim 17, wherein the polymer layer comprises polyethylene.

19. The packaging system of claim 17, wherein the metallic layer comprises aluminum.

20. The packaging system of claim 17, wherein the metal oxide layer comprises silicon oxide.

21. The packaging system of claim 1, wherein the primary package further comprises a sealed end.

22. The packaging system of claim 21, wherein the sealed end provides a fluid barrier preventing fluid communication between the storage volume and the secondary volume.

23. The packaging system of claim 21, wherein the sealed end comprises a seal formed when the storage volume contains a beneficial agent.

24. The packaging system of claim 1, further comprising a vent configured to allow fluid communication between the secondary volume and an external environment when the packaging system is in an opened state.

25. The packaging system of claim 24, wherein the rigid section comprises the vent.

26. The packaging system of claim 24, wherein the secondary package comprises the vent.

27. The packaging system of claim 1, further comprising a cap arranged to provide a fluid barrier between the dispensing port and an external environment when the packaging system is in a closed state.

28. The packaging system of claim 27, wherein the rigid section is configured to aseptically integrate with the cap.

29. The packaging system of claim 28, further comprising a venting pathway configured for fluid communication between the secondary volume and an external environment when the packaging system is in an open state with the cap removed.

30. The packaging system of claim 1, wherein the molded component comprises any of polypropylene, polyethylene, cyclic olefin polymer, or cyclic olefin copolymer.

31. The packaging system of claim 1, wherein the rigid section includes a flanged portion extending radially outward, wherein the rigid section is configured to connect to the secondary package at least partially by the flanged portion.

32. The packaging system of claim 31, wherein the flanged portion is configured to connect to the secondary package with a seal that seals the secondary volume.

33. The packaging system of claim 31, wherein the flanged portion includes a vent that extends through the flanged portion and is in fluid communication with the secondary volume.

34. The packaging system of claim 1, wherein the compartment with the flexible wall is composed of a material substantially inert relative to the beneficial agent.

35. The packaging system of claim 1, wherein the secondary package is more chemically reactive with the beneficial agent than the flexible wall.

36. The packaging system of claim 1, wherein the flexible wall is composed of a material adapted to restrict ingress of a spoiling element less than a high barrier material of the secondary package.
